(19) United States
(12) Patent Application Publication
(10) Pub. No.: US 2014/0272701 A1
(43) Pub. Date: Sep. 18, 2014

(54) TONER PARTICLE FOR HIGH SPEED SINGLE COMPONENT DEVELOPMENT SYSTEM

(71) Applicant: XEROX CORPORATION, Norwalk, CT (US)

(72) Inventors: Grazyna E. KMIECIK-LAWRYNOWICZ, Fairport, NY (US); Maura A. SWEENEY, Irondequoit, NY (US); Daniel W. ASARESE, Honeoye Falls, NY (US); Robert D. BAYLEY, Fairport, NY (US)

(73) Assignee: XEROX CORPORATION, Norwalk, CT (US)

(21) Appl. No.: 13/826,057

(22) Filed: Mar. 14, 2013

(51) Int. Cl. G03G 9/093

(52) U.S. Cl. CPC G03G 9/093
USPC 430/110.2; 430/137.11

(57) ABSTRACT

A toner composition includes toner particles containing a resin; an optional wax; and an optional colorant, wherein the resin is a three latex system including a latex core, a latex shell, and a latex gel; and a glass transition temperature Tg of the latex core is lower than a glass transition temperature Tg of the latex shell. A method of making a toner composition includes blending a latex core resin including a base polymer and a latex gel and optional additives; adding a coagulant and an acid; homogenizing the slurry; raising the temperature to a value close to the glass transition temperature of the latex core resin while stirring to form aggregated particles having a size of from about 3 to about 9 μm; adding a latex shell resin to the slurry at a controlled rate to form a batch containing toner particles having a core and a shell; adding a pH adjustment agent to the batch to freeze growth of the toner particles; coalescing the batch by increasing the temperature to a coalescence temperature that is above a glass transition temperature of the shell; monitoring the batch for particle circularity; and recovering the toner particles.

### TECHNICAL FIELD

The present disclosure is generally related to toner compositions, and methods for producing such toners, for use in forming and developing images of good quality. More specifically, this disclosure is directed to a toner containing toner particles comprising a three latex system. Such compositions are useful, for example, as toners in single component development (SCD) systems.

### BACKGROUND

Higher speed single component printers have been built to satisfy the higher demands of the office network market by, for example, incorporating augers into the printer and increasing printing speeds. Specifically, printers are being made to have a printing speed of above about 50 pages per minute (PPM). As a result of higher printing speeds, printing quality decreases because of problems associated with fusing, cleaning, and drum fog, particularly in the high humidity and heat zones (80° C./80% RH).

### SUMMARY

Provided is a toner composition comprising toner particles comprising a resin; an optional wax; and an optional colorant, wherein the resin is a three latex system comprising a latex core including a base polymer, a latex shell including a shell polymer, and a latex gel; and a glass transition temperature Tg of the latex core is lower than a glass transition temperature Tg of the latex shell. The toner particles have a particle diameter of from about 5.0 to about 9.0 μm, a circularity of from about 0.945 to about 0.990, and a BET surface area of from about 0.80 to about 1.5 m²/g.

Also provided is a method of making a toner composition comprising blending a latex core resin including a base polymer and a latex gel, optionally a wax dispersion in a surfactant, optionally a colorant dispersion, optionally a surfactant, and one or more additional optional additives; adding the coagulant and an acid; homogenizing the slurry; raising the temperature to a value near the glass transition temperature of the latex core resin while stirring to form aggregated particles of the desired size of from about 3 to about 9 μm; adding a latex shell resin to the slurry at a controlled rate to form toner particles having a shell; adding a pH adjustment agent to the batch to freeze growth of the toner particles; coalescing the batch by increasing the temperature to a coalescence temperature above the glass transition temperature of the shell; monitoring the batch for particle circularity; and recovering the toner particles by washing and drying.

### BRIEF DESCRIPTION OF THE DRAWINGS

FIG. 1 is a scanning electron microscope (SEM) image of a toner particle during its manufacture.

FIG. 2 is a SEM image of a toner particle during its manufacture.

FIG. 3 is a SEM image of a toner particle during its manufacture.

FIG. 4 is a SEM image of a toner particle during its formation.

FIG. 5 is a transmission electron microscope (TEM) image of monochrome SCD particles.

FIG. 6 is a TEM image of monochrome SCD particles.

### EMBODIMENTS

A toner composition containing toner particles comprising a resin, an optional wax, and an optional colorant, wherein the resin is a three latex system comprising a latex core including a base polymer; a latex shell including a shell polymer, and a latex gel, has a number of advantages over conventional toners. Particularly, the toner has improved high speed print performance, particularly improved minimum fusing temperature and excellent released from the fuser. Additionally, the toner has improved storage stability, drum fog in high heat and humidity (80° C./80% relative humidity), and print acuity. Furthermore, the toner allows for improved flow and matte print performance.

In this specification and the claims that follow, singular forms such as “a,” “an,” and “the” include plural forms unless the content clearly dictates otherwise. All ranges disclosed herein include, unless specifically indicated, all endpoints and intermediate values. In addition, reference may be made to a number of terms that shall be defined as follows:

The term “functional group” refers, for example, to a group of atoms arranged in a way that determines the chemical properties of the group and the molecule to which it is attached. Examples of functional groups include halogen atoms, hydroxyl groups, carboxylic acid groups, and the like.

“Optional” or “optionally” refer, for example, to instances in which subsequently described circumstance may or may not occur, and include instances in which the circumstance occurs and instances in which the circumstance does not occur.

The terms “one or more” and “at least one” refer, for example, to instances in which one of the subsequently described circumstances occurs, and to instances in which more than one of the subsequently described circumstances occurs.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

For single component developers, i.e. developers that contain no charge carriers as in two component developers, it is important for the toner particles to exhibit high transfer efficiency, including excellent flow properties and functional cohesivity. The toners described herein have appropriate compositions and physical properties to be suited for use in, for example, single component developer (SCD) machines.

Specifically, the toners described herein are suitable for use in high speed electrophotographic machines, wherein “high speed” refers to a printing rate of greater than about 50 pages per minutes (ppm), such as greater than about 52 ppm, greater than about 55 ppm, or from about 50 ppm to about 65 ppm.

### Resins and Polymers

Any monomer suitable for preparing a latex for use in a toner may be used as the base polymer, the shell polymer, or the latex gel, so long as the latex core has a lower glass transition temperature than the latex shell, and the latex gel (1) has a smaller particle size than the latex core and the latex shell; and (2) has a lower glass transition temperature than the latex core and the latex shell. Generally, the latex gel may be used as an internal release agent for improved hot offset and lowered gloss. For example, the glass transition temperature Tg of the latex core may be from about 40° C. to about 65° C., such as from about 45° C. to about 55° C., or from about 49° C. to about 53° C., while the glass transition temperature Tg of the latex shell may be from about 50° C. to about 75° C., such as from about 55° C. to about 65° C., or from about 56° C. to 62° C.

Additionally, the latex core may have a molecular weight Mw of from about 15 to about 65 kpse, such as from about 20 to about 55 kpse, or from about 30 to about 45 kpse. The latex shell may have a molecular weight Mw of from about 15 to about 75 kpse, such as from about 20 to about 60 kpse, or from about 30 to about 50 kpse.

The toner may be produced by emulsion aggregation. Suitable monomers useful in forming a latex polymer emulsion, and thus the resulting latex particles in the latex emulsion, include, for example, styrenes, acrylates, methacrylates, butadienes, isoprenes, acrylic acids, methacrylic acids, acrylonitriles, combinations thereof, and the like.

Suitable toner resins include thermoplastic resins such as vinyl resins or styrene resins, and polyesters. Suitable thermoplastic resins include styrene methacrylate; polyolefins; styrene acrylates, such as PSB-2700 obtained from Hercules-Sanyo Inc.; styrene butadienes; crosslinked styrene polymers; epoxies; polyurethanes; vinyl resins, including homopolymers or copolymers of two or more vinyl monomers; and polymeric esterification products of a dicarboxylic acid and a diol comprising a diphenol. Other suitable vinyl monomers include styrene; p-chlorostyrene; unsaturated mono-olefins such as ethylene, propylene, butylene, isobutylene, and the like; saturated mono-olefins such as vinyl acetate, vinyl propionate, and vinyl butyrate; vinyl esters such as esters of monocarboxylic acids including methyl acrylate, ethyl acrylate, n-butylacrylate, isobutyl acrylate, dodecyl acrylate, n-octyl acrylate, phenyl acrylate, methyl methacrylate, ethyl methacrylate, and butyl methacrylate; acrylonitrile; methacrylonitrile; acrylamide; mixtures thereof; and the like. In addition, crosslinked resins, including polymers, copolymers, and homopolymers of styrene polymers, may be selected.

The latex polymer may include at least one polymer. Exemplary polymers include styrene acrylates, styrene butadienes, styrene methacrylates, and more specifically, poly(styrene-alkyl acrylate), poly(styrene-1,3-diene), poly(styrene-alkyl methacrylate), poly(styrene-alkyl acrylate-acrylic acid), poly(styrene-1,3-diene-acrylic acid), poly(styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile-acrylic acid), poly(styrene-1,3-diene-acrylonitrile-acrylic acid), poly(alkyl acrylate-acrylonitrile-acrylic acid), poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene), poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), poly(styrene-butyl acrylate-acrylonitrile-acrylic acid), poly(styrene-butadiene), poly(styrene-isoprene), poly(styrene-butyl methacrylate), poly(styrene-butyl acrylate-acrylic acid), poly(styrene-butyl methacrylate-acrylic acid), poly(butyl methacrylate-butyl acrylate), poly(butyl methacrylate-acrylic acid), poly(acrylonitrile-butyl acrylate-acrylic acid), and combinations thereof. The polymers may be block, random, or alternating copolymers.

A poly(styrene-butyl acrylate) may be used as the latex polymer. The glass transition temperature of this latex may be from about 35° C. to about 75° C., such as from about 40° C. to about 70° C.

The molecular weight may be measured by mixed bed gel permeation chromatography or high flow gel permeation chromatography.

### Waxes

In addition to the resin, the toners may also contain a wax, either a single type of wax or a mixture of two or more different waxes. A single wax can be added to toner formulations, for example, to improve particular toner properties, such as toner particle shape, presence and amount of wax on the toner particle surface, charging and/or fusing characteristics, gloss, stripping, offset properties, and the like. Alternatively, a combination of waxes may be added to provide multiple properties to the toner composition.

Suitable waxes include natural vegetable waxes, natural animal waxes, mineral waxes, synthetic waxes, and functionalized waxes. Suitable natural vegetable waxes include carnauba wax, candelilla wax, rice wax, sumacs wax, jojoba oil, Japan wax, and bayberry wax. Suitable natural animal waxes include beeswax, punic wax, lanolin, lac wax, shellac wax, and spermaceti wax. Suitable mineral-based waxes include paraffin wax, microcrystalline wax, montan wax, ozokerite wax, ceresin wax, petrolatum wax, and petroleum wax. Suitable synthetic waxes include Fischer-Tropsch wax; acrylate wax; fatty acid amide wax; silicone wax; polytetrafluoroethylene wax; polyethylene wax; ester waxes obtained from higher fatty acid and higher alcohol, such as stearyl stearate and behenyl behenate; ester waxes obtained from higher fatty acid and monovalent or multivalent lower alcohol, such as butyl stearate, propyl oleate, glyceride monostearate, glyceride distearate, and pentaerythritol tetra behenate; ester waxes obtained from higher fatty acid and multivalent alcohol multimers, such as diethyleneglycol monostearate, diglyceryl distearate, dipropyleneglycol distearate, and triglyceryl tetrastearate; sorbitan higher fatty acid ester waxes, such as sorbitan monostearate; and cholesterol higher fatty acid ester waxes, such as cholesteryl stearate; polypropylene wax; and mixtures thereof.

The wax may be selected from polypropylenes and polyethylenes commercially available from Allied Chemical and Baker Petrolite (for example POLYWAX™ polyethylene waxes from Baker Petrolite), wax emulsions available from Michelman Inc. and the Daniels Products Company, EPOLENE N-15 commercially available from Eastman Chemical Products, Inc., VISCOL 550-P, a low weight average molecular weight polypropylene available from Sanyo Kasei K.K., and similar materials. The commercially available polyethylenes usually possess a molecular weight (Mw) of from about 500 to about 2,000, such as from about 1,000 to about 1,500, while the commercially available polypropylenes used have a molecular weight of from about 1,000 to about 10,000. Examples of functionalized waxes include amines, amides, imides, esters, quaternary amines, carboxylic acids or acrylic polymer emulsion, for example, JONCRYL 74, 89, 130, 537, and 538, all available from Johnson Diversey, Inc., and chlorinated polyethylenes and polypropylenes commercially available from Allied Chemical and Petrolite Corporation and Johnson Diversey, Inc. The polyethylene and polypropylene compositions may be selected from those illustrated in British Pat. No. 1,442,835, the entire disclosure of which is totally incorporated herein by reference.

The toners may contain the wax in an amount of, for example, from about 1 to about 25 wt % of the toner, such as from about 3 to about 15 wt %, or from about 5 to about 20 wt %, or from about 5 to about 12 wt %.

The wax may be a paraffin wax. Suitable paraffin waxes include paraffin waxes possessing modified crystalline structures, which may be referred to herein as modified paraffin waxes. Compared with conventional paraffin waxes, which may have a symmetrical distribution of linear carbons and branched carbons, the modified paraffin waxes may possess branched carbons in an amount of from about 1 to about 20 wt % of the wax, such as from about 8 to about 16 wt %, with linear carbons present in an in amount of from about 80 to about 99 wt %, or from about 84 to about 92 wt %.

In addition, the isomers, i.e., branched carbons, present in such modified paraffin waxes may have a number average molecular weight (Mn), of from about 520 to about 600, such as from about 550 to about 570, or about 560. The linear carbons present in such waxes may have a Mn of from about 505 to about 530, such as from about 512 to about 525, or about 518. The weight average molecular weight (Mw) of the branched carbons in the modified paraffin waxes may be from about 530 to about 580, such as from about 555 to about 575, and the Mw of the linear carbons in the modified paraffin waxes may be from about 480 to about 550, such as from about 515 to about 535.

For the branched carbons, the weight average molecular weight (Mw) of the modified paraffin waxes may demonstrate a number of carbon atoms of from about 31 to about 59 carbon atoms, such as from about 34 to about 50 carbon atoms, with a peak at about 41 carbon atoms, and for the linear carbons, the Mw may demonstrate a number of carbon atoms of from about 24 to about 54 carbon atoms, or from about 30 to about 50 carbon atoms, with a peak at about 36 carbon atoms.

The modified paraffin wax may be present in an amount of from about 2 wt % to about 20 wt % by weight of the toner, such as from about from about 4 wt % to about 15 wt %, or from about 5 wt % to about 13 wt %.

### Colorants

The toners may also contain at least one colorant. Suitable colorants or pigments include pigment, dye, mixtures of pigment and dye, mixtures of pigments, mixtures of dyes, and the like. For simplicity, the term “colorant” refers to colorants, dyes, pigments, and mixtures, unless specified as a particular pigment or other colorant component. The colorant may comprise a pigment, a dye, mixtures thereof, carbon black, magnetite, black, cyan, magenta, yellow, red, green, blue, brown, and mixtures thereof, in an amount of about 0.1 to about 35 wt % based upon the total weight of the composition, such as from about 1 to about 25 wt %.

In general, suitable colorants include Paliogen Violet 5100 and 5890 (BASF), Normandy Magenta RD-2400 (Paul Uhlrich), Permanent Violet VT2645 (Paul Uhlrich), Heliogen Green L8730 (BASF), Argyle Green XP-1,1-S (Paul Uhlrich), Brilliant Green Toner GR 0991 (Paul Uhlrich), Lithol Scarlet D3700 (BASF), Toluidine Red (Aldrich), Scarlet for Thermoplast NSD Red (Aldrich), Lithol Rubine Toner (Paul Uhlrich), Lithol Scarlet 4440, NBD 3700 (BASF), Bon Red C (Dominion Color), Royal Brilliant Red RD-8192 (Paul Uhlrich), Oracet Pink RF (Ciba Geigy), Paliogen Red 3340 and 3871K (BASF), Lithol Fast Scarlet L4300 (BASF), Heliogen Blue D6840, D7080, K7090, K6910 and L7020 (BASF), Sudan Blue OS (BASF), Neopen Blue FF4012 (BASF), PV Fast Blue B2G01 (American Hoechst), Irgalite Blue BCA (Ciba Geigy), Paliogen Blue 6470 (BASF), Sudan II, III and IV (Matheson, Coleman, Bell), Sudan Orange (Aldrich), Sudan Orange 220 (BASF), Paliogen Orange 3040 (BASF), Ortho Orange OR 2673 (Paul Uhlrich), Paliogen Yellow 152 and 1560 (BASF), Lithol Fast Yellow 0991K (BASF), Paliotol Yellow 1840 (BASF), Novaperm Yellow FGL (Hoechst), Permanerit Yellow YE 0305 (Paul Uhlrich), Lumogen Yellow D0790 (BASF), Suco-Gelb 1250 (BASF), Suco-Yellow D1355 (BASF), Suco Fast Yellow D1165, D1355 and D1351 (BASF), Hostaperm Pink E (Hoechst), Fanal Pink D4830 (BASF), Cinquasia Magenta (DuPont), Paliogen Black L9984 9BASF), Pigment Black K801 (BASF), and carbon blacks such as REGAL 330 (Cabot), Carbon Black 5250 and 5750 (Columbian Chemicals), and the like, and mixtures thereof.

Additional colorants include pigments in water-based dispersions such as those commercially available from Sun Chemical, for example SUNSPERSE BHD 6011X (Blue 15 Type), SUNSPERSE BHD 9312X (Pigment Blue 15 74160), SUNSPERSE BHD 6000X (Pigment Blue 15:3 74160), SUNSPERSE GHD 9600X and GHD 6004X (Pigment Green 7 74260), SUNSPERSE QHD 6040X (Pigment Red 122 73915), SUNSPERSE RHD 9668X (Pigment Red 185 12516), SUNSPERSE RHD 9365X and 9504X (Pigment Red 57 15850:1, SUNSPERSE YHD 6005X (Pigment Yellow 83 21108), FLEXIVERSE YFD 4249 (Pigment Yellow 17 21105), SUNSPERSE YHD 6020X and 6045X (Pigment Yellow 74 11741), SUNSPERSE YHD 600X and 9604X (Pigment Yellow 14 21095), FLEXIVERSE LFD 4343 and LFD 9736 (Pigment Black 7 77226), and the like, and mixtures thereof. Other water based colorant dispersions include those commercially available from Clariant, for example, HOSTAFINE Yellow GR, HOSTAFINE Black T and Black TS, HOSTAFINE Blue B2G, HOSTAFINE Rubine F6B, and magenta dry pigment such as Toner Magenta 6BVP2213 and Toner Magenta EO2 that may be dispersed in water and/or surfactant prior to use.

Additional suitable colorants include magnetites, such as Mobay magnetites MO8029, MO8960; Columbian magnetites, MAPICO BLACKS and surface treated magnetites; Pfizer magnetites CB4799, CB5300, CB5600, MCX6369; Bayer magnetites, BAYFERROX 8600, 8610; Northern Pigments magnetites, NP-604, NP-608; Magnox magnetites TMB-100 or TMB-104; and the like, and mixtures thereof. Specific additional examples of pigments include phthalocyanine HELIOGEN BLUE L6900, D6840, D7080, D7020, PYLAM OIL BLUE, PYLAM OIL YELLOW, PIGMENT BLUE 1 available from Paul Uhlrich & Company, Inc., PIGMENT VIOLET 1, PIGMENT RED 48, LEMON CHROME YELLOW DCC 1026, E.D. TOLUIDINE RED and BON RED C available from Dominion Color Corporation, Ltd., Toronto, Ontario, NOVAPERM YELLOW FGL, HOSTAPERM PINK E from Hoechst, and CINQUASIA MAGENTA available from E.I. DuPont de Nemours & Company, and the like. Examples of magentas include, for example, 2,9-dimethyl substituted quinacridone and anthraquinone dye identified in the Color Index as CI 60710, CI Dispersed Red 15, diazo dye identified in the Color Index as CI 26050, CI Solvent Red 19, and the like, and mixtures thereof. Illustrative examples of cyans include copper tetra(octadecyl sulfonamide) phthalocyanine, x-copper phthalocyanine pigment listed in the Color Index as CI74160, CI Pigment Blue, and Anthrathrene Blue identified in the Color Index as DI 69810, Special Blue X-2137, and the like, and mixtures thereof. Illustrative examples of yellows that may be selected include diarylide yellow 3,3-dichlorobenzidene acetoacetanilides, a monoazo pigment identified in the Color Index as CI-12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,4-dimethoxy acetoacetanilide, and Permanent Yellow FGL. Colored magnetites, such as mixtures of MAPICOBLACK and cyan components, may also be selected as pigments.

The colorant, such as carbon black, cyan, magenta, and/or yellow colorant, is incorporated in an amount sufficient to impart the desired color to the toner. In general, pigment or dye is employed in an amount ranging from about 1 to about 35 wt % of the toner particles on a solids basis, such as from about 5 to about 25 wt %, or from about 5 to about 15 wt %.

### Coagulants

Coagulants used in emulsion aggregation processes for making toners include monovalent metal coagulants, divalent metal coagulants, polyion coagulants, and the like. “Polyion coagulant” refers to a coagulant that is a salt or an oxide, such as a metal salt or a metal oxide, formed from a metal species having a valence of at least 3, at least 4, or at least 5. Suitable coagulants include, for example, coagulants based on aluminum such as polyaluminum halides such as polyaluminum fluoride and polyaluminum chloride (PAC), polyaluminum silicates such as polyaluminum sulfosilicate (PASS), polyaluminum hydroxide, polyaluminum phosphate, aluminum sulfate, and the like. Other suitable coagulants include tetraalkyl titinates, dialkyltin oxide, tetraalkyltin oxide hydroxide, dialkyltin oxide hydroxide, aluminum alkoxides, alkylzinc, dialkyl zinc, zinc oxides, stannous oxide, dibutyltin oxide, dibutyltin oxide hydroxide, tetraalkyl tin, and the like. Where the coagulant is a polyion coagulant, the coagulants may have any desired number of polyion atoms present. For example, suitable polyaluminum compounds may have from about 2 to about 13, such as from about 3 to about 8, aluminum ions present in the compound.

The coagulants may be incorporated into the toner particles during particle aggregation. As such, the coagulant may be present in the toner particles, exclusive of external additives and on a dry weight basis, in amounts of from 0 to about 5 wt % of the toner particles, such as from about greater than 0 to about 3 wt %.

### Surfactants

Colorants, waxes, and other additives used to form toner compositions may be in dispersions that include surfactants. Moreover, toner particles may be formed by emulsion aggregation methods where the resin and other components of the toner are placed in contact with one or more surfactants, an emulsion is formed, toner particles are aggregated, coalesced, optionally washed and dried, and recovered.

One, two, or more surfactants may be used. The surfactants may be selected from ionic surfactants and nonionic surfactants. Anionic surfactants and cationic surfactants are encompassed by the term “ionic surfactants.” The surfactant may be present in an amount of from about 0.01 to about 5 wt % of the toner composition, such as from about 0.75 to about 4 wt %, or from about 1 to about 3 wt %.

Suitable nonionic surfactants include methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, available from Rhone-Poulenac as IGEPAL CA-210™, IGEPAL CA-S20™, IGEPAL CA-720™, IGEPAL CO-890™, IGEPAL CO-720™, IGEPAL CO-290™, IGEPAL CA-210™, ANTAROX 890™, ANTAROX 897™, and a block copolymer of polyethylene oxide and polypropylene oxide, including those commercially available as SYNPERONIC PE/F, such as SYNPERONIC PE/F 108.

Suitable anionic surfactants include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abitic acid available from Aldrich, NEOGEN R™, NEOGEN SC™ obtained from Daiichi Kogyo Seiyaku, combinations thereof, and the like. Other suitable anionic surfactants include, DOWFAX™ 2A1, an alkyldiphenyloxide disulfonate from The Dow Chemical Company, and/or TAYCA POWER BN2060 from Tayca Corporation (Japan), which are branched sodium dodecyl benzene sulfonates. Combinations of these surfactants and any of the foregoing anionic surfactants may be used.

### Initiators

Initiators may be added for formation of the latex polymer. Suitable initiators include water soluble initiators, such as ammonium persulfate, sodium persulfate and potassium persulfate, and organic soluble initiators including organic peroxides and azo compounds including Vazo peroxides, such as VAZO 64™, 2-methyl 2-2′-azobis propanenitrile, VAZO 88™, 2-2′-azobis isobutyramide dehydrate, and combinations thereof. Other water-soluble initiators which may be used include azoamidine compounds, for example 2,2′-azobis(2-methyl-N-phenylpropionamidine)dihydrochloride, 2,2′-azobis[N-(4-chlorophenyl)-2-methylpropionamidine]di-hydrochloride, 2,2′-azobis[N-(4-hydroxyphenyl)-2-methyl-propionamidine]dihydrochloride, 2,2′-azobis[N-(4-amino-phenyl)-2-methylpropionamidine]tetrahydrochloride, 2,2′-azobis[2-methyl-N(phenylmethyl)propionamidine]dihydrochloride, 2,2′-azobis[2-methyl-N-2-propenylpropionamidine]dihydrochloride, 2,2′-azobis[N-(2-hydroxy-ethyl)-2-methylpropionamidine]dihydrochloride, 2,2′-azobis[2(5-methyl-2-imidazolin-2-yl)propane]dihydrochloride, 2,2′-azobis[2-(2-imidazolin-2-yl)propane]dihydrochloride, 2,2′-azobis[2-(4,5,6,7-tetrahydro-1H-1,3-diazepin-2-yl)propane]dihydrochloride, 2,2′-azobis[2-(3,4,5,6-tetrahydropyrimidin-2-yl)propane]dihydrochloride, 2,2′-azobis[2-(5-hydroxy-3,4,5,6-tetrahydropyrimidin-2-yl)propane]dihydrochloride, 2,2′-azobis{2-[1-(2-hydroxyethyl)-2-imidazolin-2-yl]propane}dihydrochloride, combinations thereof, and the like.

Initiators may be added in suitable amounts, such as from about 0.1 to about 8 wt % of the monomers, or from about 0.2 to about 5 wt %.

### Chain Transfer Agents

Chain transfer agents may also be used in forming the latex polymer. Suitable chain transfer agents include dodecane thiol, octane thiol, carbon tetrabromide, combinations thereof, and the like, in amounts from about 0.1 to about 10 wt %, such as from about 0.2 to about 5 wt % of monomers, to control the molecular weight properties of the latex polymer when emulsion polymerization is conducted in accordance with the present disclosure.

### Secondary Latexes

A secondary latex may be added to the non-crosslinked latex resin suspended in the surfactant. A secondary latex may refer to a crosslinked resin or polymer, or mixtures thereof, or a non-crosslinked resin as described above, that has been subjected to crosslinking.

The secondary latex may include submicron crosslinked resin particles having a size of from about 10 to about 200 nanometers in volume average diameter, such as from about 20 to 100 nanometers. The secondary latex may be suspended in an aqueous phase of water containing a surfactant, where the surfactant is present in an amount of from about 0.5 to about 5 wt % of total solids, such as from about 0.7 to about 2 wt %.

The crosslinked resin may be a crosslinked polymer such as crosslinked poly-styrene acrylates, poly-styrene butadienes, and/or poly-styrene methacrylates. Exemplary crosslinked resins include crosslinked poly(styrene-alkyl acrylate), poly(styrene-butadiene), poly(styrene-isoprene), polystyrene-alkyl methacrylate), poly(styrene-alkyl acrylate-acrylic acid), poly(styrene-butadiene-acrylic acid), poly(styrene-isoprene-acrylic acid), poly(styrenealkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile acrylic acid), crosslinked poly(alkyl acrylate-acrylonitrile-acrylic acid), and mixtures thereof.

A crosslinker, such as divinyl benzene or other divinyl aromatic or divinyl acrylate or methacrylate monomers, may be used in the crosslinked resin. The crosslinker may be present in an amount of from about 0.01 to about 25 wt % of the crosslinked resin, such as from about 0.5 to about 15 wt %.

The crosslinked resin particles may be present in an amount of from about 1 to about 20 wt % of the toner, such as from about 4 to about 15 percent by wt %, or from about 5 to about 14 wt %.

The resin used to form the toner may be a mixture of a gel resin and a non-crosslinked resin.

### Functional Monomers

A functional monomer may be included when forming a latex polymer and the particles making up the polymer. Suitable functional monomers include monomers having carboxylic acid functionality. Such functional monomers may be of the following formula (I):

[chemical structure]

where R1 is hydrogen or a methyl group; R2 and R3 are independently selected from alkyl groups containing from about 1 to about 12 carbon atoms or a phenyl group; n is from about 0 to about 20, such as from about 1 to about 10. Examples of such functional monomers include beta carboxyethyl acrylate (β-CEA), poly(2-carboxyethyl) acrylate, 2-carboxyethyl methacrylate, combinations thereof, and the like. Other functional monomers that may be used include acrylic acid and its derivatives.

The functional monomer having carboxylic acid functionality may also contain a small amount of metallic ions, such as sodium, potassium, and/or calcium, to achieve better emulsion polymerization results. The metallic ions may be present in an amount from about 0.001 to about 10 wt % of the functional monomer having carboxylic acid functionality, such as from about 0.5 to about 5 wt %.

Where present, the functional monomer may be added in amounts from about 0.01 to about 5 wt % of the toner, such as from about 0.05 to about 2 wt %.

### Aggregating Agents

Any aggregating agent capable of causing complexation may be used in forming toners of the present disclosure. Both alkali earth metal or transition metal salts can be utilized as aggregating agents. Alkali (II) salts can be selected to aggregate latex resin colloids with a colorant to enable the formation of a toner composite. Such salts include beryllium chloride, beryllium bromide, beryllium iodide, beryllium acetate, beryllium sulfate, magnesium chloride, magnesium bromide, magnesium iodide, magnesium acetate, magnesium sulfate, calcium chloride, calcium bromide, calcium iodide, calcium acetate, calcium sulfate, strontium chloride, strontium bromide, strontium iodide, strontium acetate, strontium sulfate, barium chloride, barium bromide, barium iodide, and optionally combinations thereof. Examples of transition metal salts or anions suitable as aggregating agent include acetates of vanadium, niobium, tantalum, chromium, molybdenum, tungsten, manganese, iron, ruthenium, cobalt, nickel, copper, zinc, cadmium, or silver; acetoacetates of vanadium, niobium, tantalum, chromium, molybdenum, tungsten, manganese, iron, ruthenium, cobalt, nickel, copper, zinc, cadmium, or silver; sulfates of vanadium, niobium, tantalum, chromium, molybdenum, tungsten, manganese, iron, ruthenium, cobalt, nickel, copper, zinc, cadmium, or silver; and aluminum salts such as aluminum acetate, aluminum halides such as polyaluminum chloride, combinations thereof, and the like.

### Shell

A shell may be formed on the aggregated particles. As noted above, any latex disclosed above used to form the core latex may be used to form the shell latex, as long as the glass transition temperature of the shell is greater than the glass transition temperature of the core. For example, a styrene-n-butyl acrylate copolymer may be used to form the shell latex. The shell latex may have a glass transition temperature of from about 45° C. to about 75° C., such as from about 50° C. to about 70° C., or from about 55° C. to 75° C.

Where present, a shell latex may be applied by any method within the purview of the art, including dipping, spraying, and the like. The shell latex may be applied until the desired final size of the toner particles is achieved, such as from about 3 to about 12 microns, such as from about 4 microns to about 9 microns. The shell latex may be prepared by in-situ seeded semi-continuous emulsion copolymerization of the latex and the shell latex can be added once aggregated particles have formed.

Where present, the shell latex may be present in an amount of from about 20 to about 40 wt % of the dry toner particle, such as from about 26 to about 36 wt %, or from about 27 to about 34 wt % of the dry toner particle.

### Methods

The toners may be prepared by combining a resin, a wax, and an optional colorant in the aggregation and coalescence process, followed by the washing and drying of the particles, and then blending toner particles with optional external surface additives. The resin may be prepared by any method within the purview of the art. As described above, the resin may be a three latex system comprising a latex core including a base polymer; a latex shell including a shell polymer, and a latex gel. Each of the base polymer, the shell polymer, and the latex gel may be prepared by emulsion polymerization methods. One way the resin may be prepared is by emulsion polymerization methods, including semi-continuous emulsion polymerization.

Particularly, the toners may be prepared by forming a slurry containing an emulsion containing a resin comprising a primary resin and a release resin, an optional wax, an optional coagulant, an optional surfactant, one or more additional optional additives, a pH adjustment agent, and a release agent.

The slurry may then be homogenized for about 10 to about 150 min, such as about 10 to about 50 min, about 20 to about 90 min, or about 70 to about 150 min, at a maintained homogenization temperature of about less than 40° C., such as less than about 30° C., from about 5° C. to about 30° C., or from about 0° C. to about 20° C.

After homogenization, the slurry may be mixed in a reactor at a temperature at or above the glass transition temperature of the primary resin to grow primary particles having an appropriate particle diameter, such as from about 3.0 to about 10 μm, or from about 5.0 to about 8.0 μm, or from about 5.5 to about 7.5 μm, or from about 5.8 to about 7.2 μm.

A shell resin may then be added to the slurry at a controlled rate, such as from about 0.5 to about 20%/min, from about 2 to about 10%/min, or from about 2.5 to about 6%/min, to form a batch containing toner particles. The shell resin particles may be allowed to grow and attach to the core for about 30 min, such as about 40 min, or about 1 hour.

After the shell resin particles have grown and attached to the core, a pH adjustment agent may be added to the slurry to freeze the growth of the toner particles and to raise the pH of the batch. For example, the pH may be raised to a value of to about 4 to about 6, such as to about 5 to about 5.5, to about 5.4 to about 5.8, or to about 5.7 to about 6.2.

Once growth of the particles has been frozen and the batch has been held, the temperature of the reactor may be raised to about 94° C., such as about 96° C., or about 98° C. While the batch is ramped to coalescence, the batch may be monitored for particle circularity, such as by using a Sysmex 3000 analyzer. When the circularity is from about 0.945 to about 0.998, such as from about 0.950 to about 0.980, or from about 0.955 to about 0.965, the pH may again adjusted to about 6.8, such as about 6.9, or about 7.0. The temperature in the reactor may then be set to about 60° C., such as about 63° C., or about 65° C. to cool the batch at a rate of about 0.4° C./min, such as about 0.6° C./min, or about 0.8° C./min. Once the batch has reached the reactor temperature, the pH may be adjusted to about 8.7, such as about 8.8, or about 8.9. Once the pH is adjusted, the slurry may be cooled to about 35° C., such as bout 40° C., or about 45° C., and then discharged into a sieve, sieved, washed, and dried.

### pH Adjustment Agent

A pH adjustment agent may be added to control the rate of the emulsion aggregation and the coalescence process. The pH adjustment agent may be any acid or base that does not adversely affect the products being produced. Suitable bases include metal hydroxides, such as sodium hydroxide, potassium hydroxide, ammonium hydroxide, and combinations thereof. Suitable acids include nitric acid, sulfuric acid, hydrochloric acid, citric acid, acetic acid, and combinations thereof.

### Additives

Optional additives may be combined with the toner. Suitable additives include any additives that enhance the properties of the toner composition. For example, the toner may include positive or negative charge control agents in an amount of from about 0.1 to about 10 wt % of the toner, such as from about 1 to about 5 wt %, or from about 1 to about 3 wt %. Examples of suitable charge control agents include quaternary ammonium compounds inclusive of alkyl pyridinium halides; bisulfates; alkyl pyridinium compounds, including those disclosed in U.S. Pat. No. 4,298,672, the disclosure of which is hereby incorporated by reference in its entirety; organic sulfate and sulfonate compositions, including those disclosed in U.S. Pat. No. 4,338,390, the disclosure of which is hereby incorporated by reference in its entirety; cetyl pyridinium tetrafluoroborates; distearyl dimethyl ammonium methyl sulfate; aluminum salts such as BONTRON E88™, or zinc salts such as E-84 (Orient Chemical); combinations thereof, and the like.

Other additives include an organic spacer, such as polymethylmethacrylate (PMMA). The organic spacer may have a volume average diameter of from about 300 to about 600 nm, such as from about 300 to about 400 nm, or from about 350 to about 450 nm, such as 300 nm, 350 nm, 400 nm, 450 nm, or 500 nm. For example, a 400 nanometer PMMA organic spacer may be used.

Other additives include surface additives, color enhancers, etc. Surface additives that can be added to the toner compositions after washing or drying include, for example, metal salts, metal salts of fatty acids, colloidal silicas, metal oxides, strontium titanates, combinations thereof, and the like, which additives may each be present in an amount of from about 0.1 to about 10 wt % of the toner, such as from about 0.5 to about 7 wt %. Examples of such additives include, for example, those disclosed in U.S. Pat. Nos. 3,590,000; 3,720,617; 3,655,374; and 3,983,045, the entire disclosures of which are totally incorporated herein by reference. Other additives include zinc stearate and AEROSIL R972® available from Degussa. The coated silicas of U.S. Pat. Nos. 6,190,815 and 6,004,714, the entire disclosures of which are totally incorporated herein by reference, may also be selected in amounts, for example, of from about 0.05 to about 5 wt % of the toner, such as from about 0.1 to about 2 wt %. These additives may be added during the aggregation or blended into the formed toner product.

### Toner Properties

Emulsion aggregation processes provide greater control over the distribution of toner particle sizes and by limiting the amount of both fine and coarse toner particles in the toner. In some embodiments, the toner particles have a relatively narrow particle size distribution with a lower number ratio geometric standard deviation (GSDn) of from about 1.15 to about 1.35, such as from about 1.15 to about 1.30, or from about 1.15 to about 1.25. The toner particles may also exhibit an upper geometric standard deviation by volume (GSD) in the range of from about 1.15 to about 1.35, such as from about 1.15 to about 1.30, or from about 1.15 to about 1.25.

The toner particles may have a particle diameter of from about 3.0 to about 10 μm, such as from about 5.0 to about 8.0 μm, from about 5.5 to about 7.5 μm. The particle diameter may be measured using any known means, such as by using a scanning electron microscope (SEM). With a proper circularity, the toners may assist in optimized machine performance.

The toner particles may have a circularity of about 0.945 to about 0.998, such as about 0.945 to about 0.980, or about 0.950 to about 0.970, or about 0.955 to about 0.965, and, thus, may be especially suited for blade cleaning systems, i.e., single component development (SCD) systems. A circularity of above about 0.965 tends to result in toners having drum fog issues, particularly morning drum fog in a high humidity/high heat (80° C./80% RH) zone. Circularity may be measured with, for example, a Sysmex FPIA 2100 or 3000 analyzer. A circularity of 1.000 indicates a completely circular shape.

The toner particles may have a surface area of from about 0.5 m²/g to about 1.4 m²/g, such as from about 0.6 m²/g to about 1.2 m²/g, or from about 0.7 m²/g to about 1.10 m²/g. Surface area may be determined by the Brunauer, Emmett, and Teller (BET) method. BET surface area of a sphere can be calculated by the following equation:

Surface Area (m²/g)=6/(Particle Diameter (um)*Density (g/cc)).

The toner particles may have a volume average diameter (also referred to as “volume average particle diameter” or “D₅₀ᵥ”) of from about 3 to about 25 μm, such as from about 4 to about 15 μm, or from about 5 to about 12 μm, or from about 6.5 to about 8 μm. D₅₀ᵥ, GSDv, and GSDn may be determined using a measuring instrument such as a Beckman Coulter Multisizer 3, operated in accordance with the manufacturer's instructions. Representative sampling may occur as follows: a small amount of toner sample, about 1 gram, may be obtained and filtered through a 25 micrometer screen, then put in isotonic solution to obtain a concentration of about 10%, with the sample then run in a Beckman Coulter Multisizer 3.

The toner particles may have a shape factor of from about 105 to about 170, such as from about 110 to about 140, or from about 130 to about 150. Scanning electron microscopy (SEM) may be used to determine the shape factor analysis of the toners by SEM and image analysis (IA). The average particle shapes are quantified by employing the following shape factor (SF1*a) formula: SF1*a 100πd²/(4A), where A is the area of the particle and d is its major axis. A perfectly circular or spherical particle has a shape factor of exactly 100. The shape factor SF1*a increases as the shape becomes more irregular or elongated in shape with a higher surface area.

The toner particles may have a weight average molecular weight (Mw) in the range of from about 10,000 to about 65,000 pse, a number average molecular weight (Mn) of from about 2,500 to about 30,000 pse, and an MWD (a ratio of the Mw to Mn of the toner particles, a measure of the polydispersity, or width, of the polymer) of from about 1.2 to about 10.

The characteristics of the toner particles may be determined by any suitable technique and apparatus and are not limited to the instruments and techniques indicated hereinabove.

Further, the toners, if desired, can have a specified relationship between the molecular weight of the latex binder and the molecular weight of the toner particles obtained following the emulsion aggregation procedure. As understood in the art, the binder undergoes crosslinking during processing, and the extent of crosslinking can be controlled during the process. The relationship can best be seen with respect to the molecular peak values (Mp) for the binder, which represents the highest peak of the Mw. The binder may have Mp values in the range of from about 5,000 to about 50,000 pse, such as from about 7,500 to about 45,000. The toner particles prepared from the binder also exhibit a high molecular peak, for example, of from about 5,000 to about 43,000, such as from about 7,500 to about 40,500 pse, indicating that the molecular peak is driven by the properties of the binder rather than another component such as the colorant.

Toners of the present disclosure have excellent properties including minimum fix, fusing ratio, and density. For example, the toners may possess low minimum fix temperatures, i.e., temperatures at which images produced with the toner may become fixed to a substrate, of from about 135° C. to about 220° C., such as from about 155° C. to about 220° C. The toners may have a fusing percentage of from about 50% to about 100%, or from about 60% to about 90%. The fusing percentage of an image may be evaluated in the following manner Toner is fused from low to high temperatures depending upon initial setpoint. Toner adherence to paper is measured by tape removal of the areas of interest with subsequent density measurement. The density of the tested area is divided by the density of the area before removal then multiplied by 100 to obtain percent fused. The optical density is measured with a spectrometer (for example, a 938 Spectrodensitometer, manufactured by X-Rite). Then, the optical densities thus determined are used to calculate the fusing ratio according to the following Equation.

$$Fusing ( \% ) = \frac{Area after removal}{Area before removal} \times 100$$

The toners may also possess excellent charging characteristics when exposed to extreme relative humidity (RH) conditions. The low-humidity zone may be about 12° C./15% RH, while the high humidity zone may be about 28° C./85% RH. Toners of the present disclosure may possess a parent toner charge per mass ratio (Q/M) in the low-humidity zone of from about −25 μC/g to about −95 μC/g, such as from about −45 μC/g to about −95 μC/g, and a final toner charging after surface additive blending of from −8 μC/g to about −90 μC/g, such as from about −50 μC/g to about −85 μC/g. Toners of the present disclosure may possess a parent toner charge per mass ratio (Q/M) in the high-humidity zone of from about −2 μC/g to about −50 μC/g, such as from about −4 μC/g to about −35 μC/g, and a final toner charging after surface additive blending of from −8 μC/g to about −40 μC/g, such as from about −10 μC/g to about −25 μC/g.

The toners may exhibit a high hot offset temperature of, for example, from about 200° C. to about 230° C., such as from about 200° C. to about 220° C., or from about 205° C. to about 215° C.

The toner compositions may have a flow, measured by Hosakawa Powder Flow Tester. Toners of the present disclosure may exhibit a flow of from about 5 to about 55%, or from about 10 to about 50%.

The toner composition may be measured for compressibility, which is partly a function of flow. Toners of the present disclosure may exhibit a compressibility of from about 8 to about 14%, or from about 10 to about 12% at 9.5-10.5 kPa.

The drum contamination after using the toner compositions may be measured by removing the drum and subsequently weighing. Toners of the present disclosure may exhibit a drum contamination from about 0 to about 20%, or from about 1 to about 8%.

The density of the toner compositions may be measured by densitometer. Toners of the present disclosure may exhibit a density of from about 1.1 to about 1.6, or from about 1.1 to about 1.4.

### Imaging

Toners in accordance with the present disclosure may be used in a variety of imaging devices including printers, copy machines, and the like. The toners generated in accordance with the present disclosure are excellent for imaging processes, especially xerographic processes, and are capable of providing high quality colored images with excellent image resolution, acceptable signal-to-noise ratio, and image uniformity. Further, toners of the present disclosure may be selected for electrophotographic imaging and printing processes such as digital imaging systems and processes.

Any known type of image development system may be used in an image developing device to form images with the toner set described herein, including, for example, magnetic brush development, single component development (SCD), two component development (TCD) system, hybrid scavengeless development (HSD), and the like. Because these development systems are known in the art, and further explanation of the operation of these devices to form an image is not needed.

As described above, the toner composition is suitable for use in high speed electrophotographic machines, such as those having a printing rate of at least about 50 ppm.

One benefit of the formulation disclosed herein that the reduction in contamination of the bias charge roll (BCR). These toners are particularly well-suited for use in printers with cleaning systems including a BCR and electrostatic roll for charging the photoreceptor. This means that the formulations are also particularly well-suited for use in small office printers.

### EXAMPLES

The following Examples are being submitted to illustrate embodiments of the present disclosure. These Examples are intended to be illustrative only and are not intended to limit the scope of the present disclosure. Also, parts and percentages are by weight unless otherwise indicated. “Room temperature” refers to a temperature of from about 20° C. to about 30° C.

Toner particles are made by combining the latex core, latex gel, paraffin wax, carbon black pigment, cyan pigment, polyaluminum chloride (PAC), and nitric acid (HNO₃) in the amounts shown in Table 1 to form a slurry.

TABLE 1
Monochrome SCD Formulation

| Particle | Use | Wt % |
|---|---|---|
| Latex Core | Base Polymer | 42-52 |
| Latex Shell | Shell Polymer | 26-36 |
| Latex Gel | Release | 6-12 |
| Paraffin Wax | Release | 10-14 |
| Regal 330 CB Pigment | Pigmentation | 2-6 |
| Cyan 15:3 Pigment | Pigmentation | 0.5-2.5 |
| PAC-100 | Coagulant | 0.12-0.18 pph |
| HNO₃ | Acid | Adjust |
| NaOH | Base | Adjust |

The mixture is homogenized for 20-90 minutes while maintaining a temperature of 30° C. or less. After homogenization, the mixture is taken out of the homogenizer loop and is mixed in a reactor at a controlled rate and temperature, which is at or above the glass transition temperature of the primary (base) polymer. Once the primary particle has reached an appropriate size, the shell resin is added at a controlled rate. The shell resin is allowed to grow for 30 minutes until desired growth and proper attachment to the core is achieved.

After the shell addition, a base is added to freeze the growth of the particle and to rise the pH to 4.0 to 6.0. After the particle growth has been frozen and the batch has been held, the temperature is increased to 96° C. Ramp to coalescence is carefully watched and, at 80° C., the pH is adjusted to 4.9 to 5.3. Once the coalescence of 96° C. is achieved, the batch is monitored for particle circularity, using a Sysmex 3000 analyzer.

Once the circularity is 0.960, the pH is adjusted to 6.8 to 7.0. The temperature in the reactor is then set to 58-63° C. and the slurry is cooled at a rate of about 0.4-0.6° C./min. Once the slurry reaches a temperature of about 58-63° C., the pH is adjusted to 8.5 to 8.9, and then the temperature of the slurry is lowered to 30-40° C. Once lowered to 30-40° C., the slurry is discharged into a sieve, sieved, and then washed and dried.

FIGS. 1-4 are SEM images showing the manufacturing scale up of the particle having a size of 7.0 to 7.8 μm and a circularity of 0.955 to 0.965. FIGS. 5 and 6 are TEM images showing the pigment and wax distribution throughout the particles.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A toner composition comprising:
toner particles comprising:
a resin;
an optional wax; and
an optional colorant,
wherein:
the resin is a three latex system comprising:
a latex core including a base polymer;
a latex shell including a shell polymer; and
a latex gel; and
a glass transition temperature Tg of the latex core is lower than a glass transition temperature Tg of the latex shell.

2. The toner composition of claim 1, wherein the toner particles have a particle diameter of from about 3 to about 10 μm.

3. The toner composition of claim 1, wherein the toner particles have a circularity of from about 0.945 to about 0.998.

4. The toner composition of claim 1, wherein the toner particles have a BET surface area of from about 0.8 m²/g to about 1.5 m²/g.

5. The toner composition of claim 1, wherein the toner composition is a single component toner composition.

6. The toner composition of claim 1, wherein:
the glass transition temperature Tg of the latex core is from about 40° C. to about 65° C.; and
the glass transition temperature Tg of the latex shell is from about 50° C. to about 75° C.

7. The toner composition of claim 1, wherein:
a molecular weight Mw of the latex core is from about 15 kpse to about 65 kpse; and
a molecular weight Mw of the latex shell is from about 15 kpse to about 65 kpse.

8. The toner composition of claim 1, wherein the toner composition is configured to be used in high speed electrophotographic machines having a print rate of at least about 50 pages per minute.

9. A method of making a toner composition comprising:
forming a slurry containing particles by combining:
an emulsion containing a resin comprising a latex core resin including a base polymer resin and a latex gel;
a release resin;
optionally a wax dispersion in a surfactant;
optionally a colorant dispersion;
and
one or more additional optional additives;
adding an acid and a coagulant;
homogenizing the slurry and aggregating the particles at a homogenization temperature;
adding a latex shell resin to the to form a batch containing toner particles having a core and a shell;
adding a pH adjustment agent to the batch to freeze growth of the toner particles and to adjust a pH of the batch;
coalescing the batch by increasing the temperature to a coalescence temperature;
monitoring the batch for particle circularity; and
recovering the toner particles.

10. The method of claim 9, wherein the toner particles have a final particle diameter of from about 3.0 to about 10 μm.

11. The method of claim 9, wherein the toner particles have a final circularity of from about 0.945 to about 0.998.

12. The method of claim 9, wherein a glass transition temperature Tg of the latex core is lower than a glass transition temperature Tg of the latex shell.

13. The method of claim 9, wherein aggregating the particles occurs at a temperature that is about the same as a glass transition temperature of the core.

14. The method of claim 9, wherein the coalescence temperature is above a glass transition temperature of the shell.

15. The method of claim 9, wherein the base rises the pH of the batch to a range from about 4 to about 6.0.

16. The method of claim 9, further comprising adjusting the pH of the batch to a value of from about 4.9 to about 5.3 when the temperature of the batch reaches about 80° C. during ramping to coalescence.

17. The method of claim 9, further comprising adjusting the pH of the batch to a range of about 6.8 to about 7.0 once the toner particles have a circularity of from about 0.945 to about 0.998.

18. The method of claim 9, further comprising cooling the slurry and subsequently adjusting the pH of the slurry after the toner particles have a circularity of from about 0.945 to about 0.998.

19. A toner composition comprising:
toner particles comprising:
a resin;
an optional wax; and
an optional colorant,
wherein:
the resin is a three latex system comprising:
a latex core including a base polymer;
a latex shell including a shell polymer; and
a latex gel;
the toner particles have a particle diameter of from about 7.3 to about 10 μm;
the toner particles have a circularity of from about 0.945 to about 0.998; and
the toner particles have a BET surface area of from about 0.8 m²/g to about 1.5 m²/g.

20. The toner composition of claim 20, wherein a glass transition temperature Tg of the latex core is lower than a glass transition temperature Tg of the latex shell.
